(19) United States
(12) Patent Application Publication
(10) Pub. No.: US 2015/0062708 A1
(43) Pub. Date: Mar. 5, 2015

(54) OPTICAL DEVICE, OPTICAL MODULE, ELECTRONIC APPARATUS, OPTICAL HOUSING, AND METHOD OF MANUFACTURING OPTICAL HOUSING

(71) Applicant: Seiko Epson Corporation, Tokyo (JP)

(72) Inventors: Yasushi MATSUNO, Matsumoto (JP); Daisuke SAITO, Matsumoto (JP); Hideo IMAI, Shimosuwa (JP); Shigemitsu KOIKE, Suwa (JP)

(21) Appl. No.: 14/475,942

(22) Filed: Sep. 3, 2014

(30) Foreign Application Priority Data
Sep. 5, 2013 (JP) 2013-183796

(51) Int. Cl. G02B 26/00; G02B 27/00; G02B 5/28

(52) U.S. Cl. CPC G02B 26/001; G02B 5/284; G02B 27/0006
USPC 359/578; 359/577

(57) ABSTRACT

An optical filter device includes a wavelength tunable interference filter, a lid having a second opening, a base that forms a receiving space together with the lid, a second glass member that covers the second opening and is bonded to the lid through low melting point glass, and a metal layer provided on the lid. The metal layer is provided outside a line that is separated from the outer peripheral edge of the second glass member by a predetermined distance toward a side away from the second opening and is disposed along the outer peripheral edge of the second glass member in plan view when the lid is viewed from a normal direction with respect to the opening surface of the second opening.

### BACKGROUND

1. Technical Field

The present invention relates to an optical device, an optical module, an electronic apparatus, an optical housing, and a method of manufacturing an optical housing.

2. Related Art

An optical device in which an optical element, such as an interference filter or a mirror device, is housed in a hermetically sealed housing is known (for example, refer to JP-A-2005-93675).

The optical device disclosed in JP-A-2005-93675 includes a container-like substrate, a metal frame body that blocks an opening of the substrate and has an opening for light transmission, and a glass member that blocks the opening of the metal frame body. A bonding material of low melting point glass is provided in a region of the metal frame body facing the glass member, and the metal frame body and the glass member are bonded to each other by the bonding material. In a region of the metal frame body not facing the glass member, a metal layer for anti-corrosion of the metal frame body is provided using a plating method.

Incidentally, in order to ensure satisfactory bonding strength and airtightness by bonding the glass member and the metal frame body to each other through the low melting point glass, it is preferable to form a fillet of low melting point glass along the outer periphery of the glass member.

On the other hand, in JP-A-2005-93675, the bonding material is provided only in a region of the metal frame body surface facing the glass member. For this reason, there is a problem in that bonding strength and airtightness are not sufficient.

In addition, in JP-A-2005-93675, when a fillet is formed, a metal layer is formed in a region of the metal frame body not facing the glass member using the plating method. Accordingly, a fillet of low melting point glass is formed on the metal layer. In this case, due to the difference in thermal expansion coefficient between the metal frame body and the metal layer according to the plating method, cracking occurs in the metal layer according to the plating method. The low melting point glass also cracks due to the cracking of the metal layer. In this case, there is a problem in that the bonding strength or airtightness between the glass member and the metal frame body is reduced.

### SUMMARY

An advantage of some aspects of the invention is to provide an optical device with high bonding strength and airtightness, an optical module, an electronic apparatus, an optical housing, and a method of manufacturing an optical housing.

An aspect of the invention is directed to an optical device including: an optical element; a first member that is disposed so as to cover the optical element and has an opening; a second member that is disposed so as to face the first member with the optical element interposed therebetween and that houses the optical element together with the first member; a third member that covers the opening so as to transmit light; and a metal layer that covers the first member. When a side of the opening is viewed from the third member, the metal layer does not overlap the third member on a side of the first member facing the third member.

The optical device according to the aspect of the invention includes an optical element having a light receiving surface or a light emitting surface, a first member having an opening, a second member that forms a receiving space capable of housing the optical element together with the first member, a light transmissive member that is bonded to the first member so as to cover the opening, and a metal layer provided on the first member, and the metal layer is provided at a position separated from the outer peripheral edge of the light transmissive member by a predetermined distance toward a side away from the opening in plan view when viewed from the normal direction with respect to the opening surface of the opening.

In the aspect of the invention, the light transmissive member is bonded to the first member. In addition, in the first member, the metal layer is provided so as to be separated from the outer peripheral edge of the light transmissive member outward by the predetermined distance. The metal layer can be formed using a plating method. That is, the metal layer is not provided in a region (hereinafter, referred to as a first region in some cases) from a position, which is away from the outer peripheral edge of the light transmissive member outward by the predetermined distance, to the opening edge of the opening, and the metal layer is provided in a region (hereinafter, referred to as a second region in some cases) other than the first region. In addition, the metal layer may not be provided in the first region. For example, the metal layer may be formed in the entire second region, or may be provided in a part of the second region.

In such a configuration, the metal layer and a bonding material for bonding the light transmissive member to the first member are not in contact with each other. Therefore, even if adhesion between the metal layer and the bonding material is poor or the thermal expansion coefficients of the metal layer and the bonding material are different, it is possible to suppress deterioration or cracking in the metal layer. As a result, it is possible to maintain the corrosion resistance of the first member by using the metal layer. In addition, since the cracking of the bonding material due to cracking of the metal layer does not occur either, it is possible to bond the first member and the light transmissive member to each other with high bonding strength and high airtightness.

In addition, since the first region reaches the position of the line separated from the outer peripheral edge of the light transmissive member by the predetermined distance, it is possible to form a fillet of the bonding material along the outer peripheral edge of the light transmissive member in the first region. By forming such a fillet, it is possible to further improve the bonding strength and airtightness of the first member and the light transmissive member.

In the optical device according to the aspect of the invention, it is preferable that the light transmissive member is bonded to the first member through low melting point glass.

With this configuration, the light transmissive member is bonded to the first member through the low melting point glass. By the bonding using the low melting point glass, it is possible to improve the airtightness of the light transmissive member and the first member.

In the optical device according to the aspect of the invention, it is preferable that the optical device further includes a resin member that covers a surface of the low melting point glass that is not in contact with the light transmissive member and the first member.

With this configuration, the surface of the low melting point glass that is not in contact with the light transmissive member or the first member is covered by the resin member, in addition to the bonding using the low melting point glass. Therefore, it is possible to further improve the bonding strength and airtightness of the low melting point glass.

In addition, by providing the resin member so as to also be in contact with the light transmissive member and the first member, the light transmissive member can be pressed toward the first member side due to contraction of the resin member at the time of curing. Accordingly, it is also possible to improve the bonding strength.

In the optical device according to the aspect of the invention, it is preferable that, in plan view when viewed from the normal direction with respect to the opening surface of the opening, the metal layer is provided so as to cover a region other than a region from the line, which is separated from the outer peripheral edge of the light transmissive member by the predetermined distance toward a side away from the opening and is disposed along the outer peripheral edge of the light transmissive member, to the opening edge of the opening, and the resin member covers a region, in which the low melting point glass is not provided, of the region between the line and the opening edge of the opening.

With this configuration, the first member is covered by the metal layer in the second region, and is covered by the resin member in a region where the low melting point glass is not in contact with the first member in the first region. That is, the entire first member is covered by any of the low melting point glass, the metal layer, and the resin member. By adopting such a configuration, it is possible to improve corrosion resistance without the surface of the first member being exposed to the outside.

In the optical device according to the aspect of the invention, it is preferable that the light transmissive member has a flat surface portion facing the first member and an inclined surface portion that is continuous with an outer peripheral edge side of the light transmissive member from the flat surface portion and is inclined in a direction away from the first member toward the outer peripheral edge of the light transmissive member, the low melting point glass is disposed between the flat surface portion and the first member, and the resin member is in contact with the inclined surface portion of the light transmissive member.

With this configuration, the low melting point glass is provided between the first member and the flat surface portion. In such a configuration, a fillet of the low melting point glass can be formed toward the first member from the end of the flat surface portion. Therefore, as described above, it is possible to improve the bonding strength and airtightness of the first member and the light transmissive member.

The resin member is in contact with the inclined surface portion of the light transmissive member. That is, the resin member is provided between the inclined surface portion of the light transmissive member and the first member or between the inclined surface portion of the light transmissive member and a surface (non-bonding surface) of the low melting point glass that is not in contact with the first member and the light transmissive member. In such a configuration, since the resin member contracts at the time of curing, the light transmissive member can be pressed toward the first member side where the light transmissive member is interposed therebetween. Therefore, it is possible to further improve bonding strength and airtightness.

In the optical device according to the aspect of the invention, it is preferable that the light transmissive member is formed of glass, the first member is formed of Kovar, and the metal layer contains nickel.

With this configuration, Kovar is used as the first member, and a plating material containing nickel can be used as the metal. In this case, since the adhesion of nickel to Kovar is high, it is possible to suppress the peeling of the metal. As a result, it is possible to maintain the corrosion resistance of Kovar satisfactorily.

In addition, by using the light transmissive member formed of glass and the first member formed of Kovar having thermal expansion coefficients close to each other, it is possible to reduce disadvantages, such as cracking that occurs in the low melting point glass due to a thermal expansion coefficient difference at the time of bonding using the low melting point glass as a bonding member. Therefore, it is possible to improve bonding strength and airtightness.

In the optical device according to the aspect of the invention, it is preferable that the optical element is an interference filter including a pair of reflective films facing each other.

With this configuration, when the reflective film used in the interference filter is deteriorated due to, for example, oxidation, the resolution of light emitted from the interference filter is reduced. Therefore, in particular, it is necessary to maintain the inside of the optical device in a decompressed state (more preferably, in a vacuum state) to maintain it hermetically. In addition, when the interference filter is configured so as to be able to change the size of a gap between reflective films, for example, by an electrostatic actuator, it is preferable to maintain the inside of the optical device in a decompressed state (more preferably, in a vacuum state) to maintain it hermetically in order to improve responsiveness at the time of driving.

In contrast, in the optical device according to the aspect of the invention with the configuration described above, the light transmissive member and the first member are bonded to each other with high bonding strength and high airtightness as described above. Therefore, since the inside of the optical device can be maintained under an appropriate environment (decompressed or vacuum state), it is possible to suppress the performance degradation of the interference filter.

Another aspect of the invention is directed to an optical module including: an optical device that includes an interference filter including a pair of reflective films facing each other, a first member having an opening, a second member that is disposed so as to face the first member with the interference filter interposed therebetween and that houses the interference filter together with the first member, a third member that covers the opening so as to transmit light, and a metal layer that covers the first member; and a light receiving unit that receives light emitted from the interference filter. When a side of the opening is viewed from the third member, the metal layer does not overlap the third member on a side of the first member facing the third member.

The optical module includes an optical device, which includes an interference filter including a pair of reflective films facing each other, a first member having an opening, a second member that forms a receiving space capable of housing the interference filter together with the first member, a light transmissive member that is bonded to the first member so as to cover the opening, and a metal layer provided on the first member, and a light receiving unit that receives light emitted from the interference filter. The metal layer is provided at a position separated from the outer peripheral edge of the light transmissive member by a predetermined distance toward a side away from the opening in plan view when viewed from the normal direction with respect to the opening surface of the opening.

With this configuration, since the bonding strength and airtightness of the first member and the light transmissive member in the optical device can be improved as described above, it is possible to maintain the inside of the optical device under an appropriate environment. Therefore, since it is possible to suppress the performance degradation of the interference filter, light having a desired wavelength can be emitted from the interference filter with high resolution. As a result, also in the optical module, the light receiving unit can accurately detect the amount of light having a desired wavelength.

Still another aspect of the invention is directed to an electronic apparatus including: an optical device that includes an interference filter including a pair of reflective films facing each other, a first member having an opening, a second member that is disposed so as to face the first member with the interference filter interposed therebetween and that houses the interference filter together with the first member, a third member that covers the opening so as to transmit light, and a metal layer that covers the first member; and a control unit that controls the interference filter. When a side of the opening is viewed from the third member, the metal layer does not overlap the third member on a side of the first member facing the third member.

The electronic apparatus includes an optical device, which includes an interference filter including a pair of reflective films facing each other, a first member having an opening, a second member that forms a housing space capable of housing the interference filter together with the first member, a light transmissive member that is bonded to the first member so as to cover the opening, and a metal layer provided on the first member, and a control unit that controls the interference filter. The metal layer is provided at a position separated from the outer peripheral edge of the light transmissive member by a predetermined distance toward a side away from the opening in plan view when viewed from the normal direction with respect to the opening surface of the opening.

With this configuration, since the bonding strength and airtightness of the first member and the light transmissive member in the optical device can be improved as described above, it is possible to maintain the inside of the optical device under an appropriate environment. Therefore, when the control unit controls the interference filter, it is possible to perform highly accurate control. As a result, it is possible to improve the performance of the electronic apparatus.

Yet another aspect of the invention is directed to an optical housing including: a first member that has an opening; a second member that houses an optical element together with the first member; a third member that covers the opening so as to transmit light; and a metal layer that covers the first member. When a side of the opening is viewed from the third member, the metal layer does not overlap the third member on a side of the first member facing the third member.

The optical housing includes a first member having an opening, a light transmissive member that is bonded to the first member so as to cover the opening, and a metal layer provided on the first member, and the metal layer is provided at a position separated from the outer peripheral edge of the light transmissive member by a predetermined distance toward a side away from the opening in plan view when viewed from the normal direction with respect to the opening surface of the opening.

With this configuration, as described above, the light transmissive member is bonded in the first region of the first member using a bonding material, and the metal layer is provided in the second region. For this reason, neither the cracking of the metal layer nor the cracking of the bonding material due to contact between the bonding material and the metal layer occurs. In addition, since a fillet of the bonding material can also be provided in the first region, the fillet does not come in contact with the metal layer even if the fillet is formed. Therefore, it is possible to maintain the corrosion resistance of the first member by the metal layer and to improve the bonding strength and airtightness of the first member and the light transmissive member.

Still yet another aspect of the invention is directed to a method of manufacturing an optical housing which includes a first member having an opening, a second member for housing an optical element together with the first member, a third member that covers the opening so as to transmit light, and a metal layer that covers the first member and in which the metal layer does not overlap the third member on a side of the first member facing the third member when a side of the opening is viewed from the third member. The method of manufacturing an optical housing includes: plating a metal layer in a second region of the first member; and bonding the third member to a first region of the first member. When the side of the opening is viewed from the third member, the first region includes a region between an outer peripheral edge of the third member and an opening edge of the opening, and the second region is a region other than the first region.

The method of manufacturing an optical housing is a method of manufacturing an optical housing including a first member having an opening, a light transmissive member that covers the opening and is bonded to the first member, and a metal layer provided on the first member. The first member has a first region and a second region other than the first region. The first region is a region between a line, which is separated from the outer peripheral edge of the light transmissive member by a predetermined distance toward a side away from the opening and is disposed along the outer peripheral edge of the light transmissive member in plan view when viewed from the normal direction with respect to the opening surface of the opening, and the opening edge of the opening. The manufacturing method includes plating the metal layer in the second region of the first member and bonding the light transmissive member, which covers the opening, to the first region of the first member.

With this configuration, the metal layer is formed in the second region in the plating step. As such a metal layer forming method, for example, a metal layer may be formed on the entire first member and then the metal layer in the first region may be removed using various methods, such as etching or polishing, or the metal layer may be formed after masking a portion corresponding to the first region. Then, in the bonding process, the light transmissive member and the first member are bonded to each other through the bonding material in the first region. Here, the first region is set as a region from the line, which is separated from the outer peripheral edge of the light transmissive member outward by the predetermined distance, to the opening edge of the opening. Accordingly, even if a fillet is formed along the outer peripheral edge of the light transmissive member, the fillet does not come in contact with the metal. For this reason, there is no cracking of the bonding material due to contact between the fillet and the metal. As a result, it is possible to bond the first member and the light transmissive member to each other with high bonding strength and high airtightness.

### BRIEF DESCRIPTION OF THE DRAWINGS

The invention will be described with reference to the accompanying drawings, wherein like numbers reference like elements.

FIG. 1 is a plan view schematically showing an optical filter device of a first embodiment.

FIG. 2 is a cross-sectional view of the optical filter device of the first embodiment.

FIG. 3 is a plan view of the wavelength tunable interference filter of the first embodiment.

FIG. 4 is a cross-sectional view of the wavelength tunable interference filter of the first embodiment.

FIG. 5 is an enlarged cross-sectional view of a part of a lid of the first embodiment.

FIG. 6 is a flowchart showing the process of manufacturing the optical filter device of the first embodiment.

FIG. 7 is an enlarged cross-sectional view of a part of a lid of a second embodiment.

FIG. 8 is an enlarged cross-sectional view of a part of a lid of a third embodiment.

FIG. 9 is a diagram showing a change in the internal pressure of the optical filter device of each embodiment.

FIG. 10 is a block diagram showing the schematic configuration of a colorimetric apparatus of a fourth embodiment.

FIG. 11 is a diagram showing the schematic configuration of a gas detector that is an example of an electronic apparatus.

FIG. 12 is a block diagram showing the configuration of a control system of the gas detector shown in FIG. 11.

FIG. 13 is a diagram showing the schematic configuration of a food analyzer that is an example of an electronic apparatus.

FIG. 14 is a diagram showing the schematic configuration of a spectral camera that is an example of an electronic apparatus.

### DESCRIPTION OF EXEMPLARY EMBODIMENTS

### First Embodiment

Hereinafter, a first embodiment of the invention will be described with reference to the accompanying diagrams.

### Configuration of Optical Filter Device

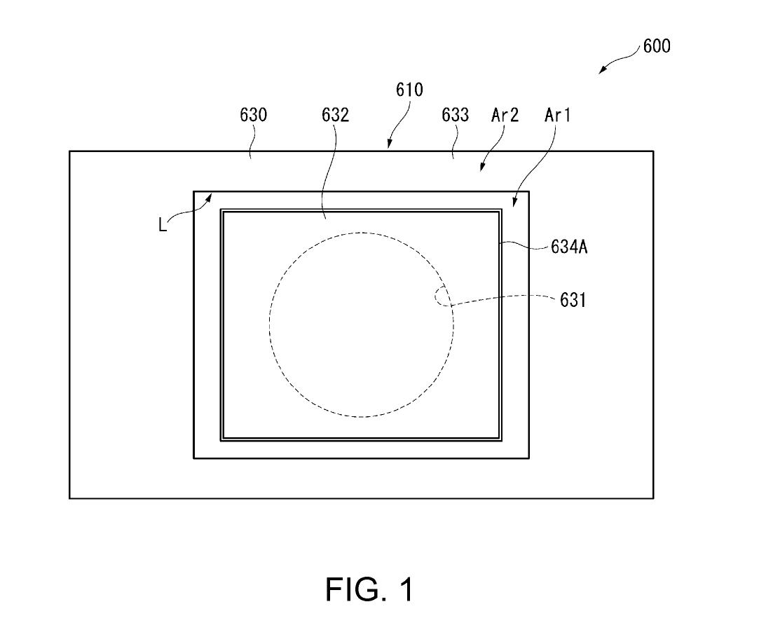

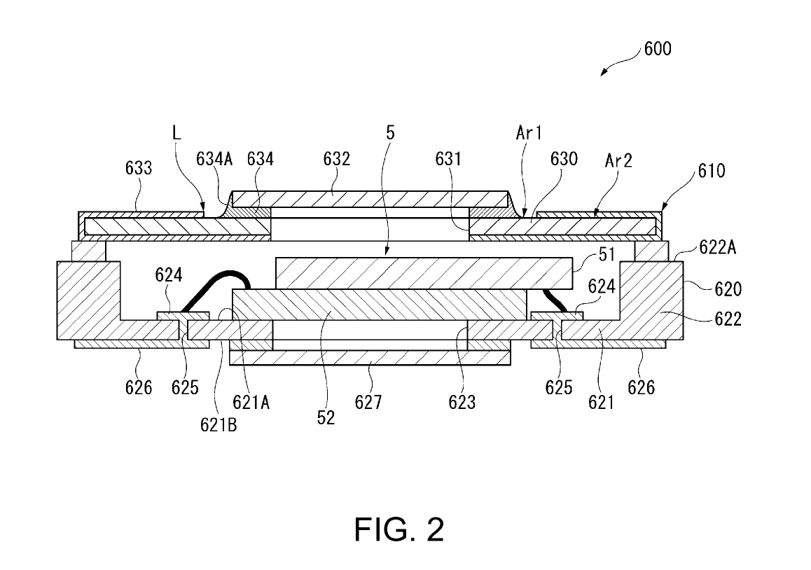

FIG. 1 is a plan view showing the schematic configuration of an optical filter device 600 that is an embodiment of an optical device according to the invention. FIG. 2 is a cross-sectional view of the optical filter device 600.

The optical filter device 600 is a device that extracts light having a predetermined target wavelength from incident test target light and emits the extracted light, and includes a housing 610 (optical housing according to the invention) and a wavelength tunable interference filter 5 housed in the housing 610. The optical filter device 600 can be assembled into an optical module, such as a colorimetric sensor, or an electronic apparatus, such as a colorimetric apparatus or a gas analyzer, for example. The configuration of an optical module or an electronic apparatus including the optical filter device 600 will be described in detail later.

### Configuration of Wavelength Tunable Interference Filter

The wavelength tunable interference filter 5 is an example of the optical element according to the invention.

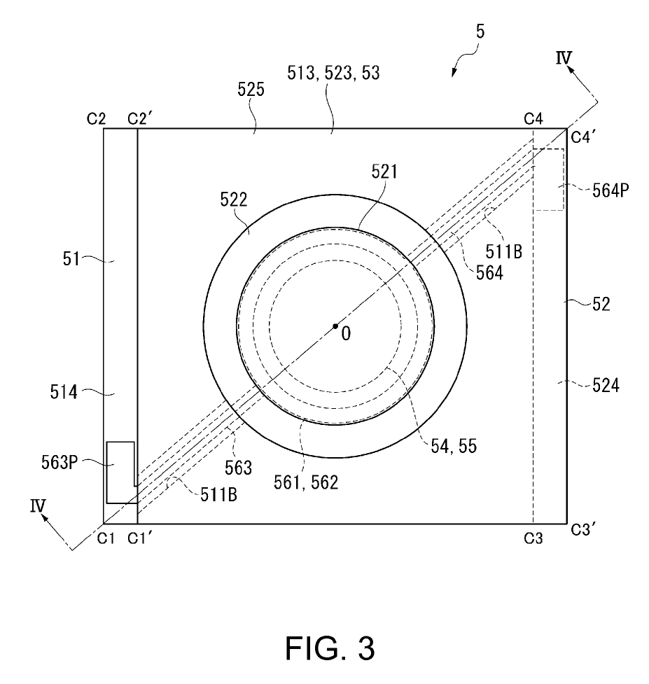

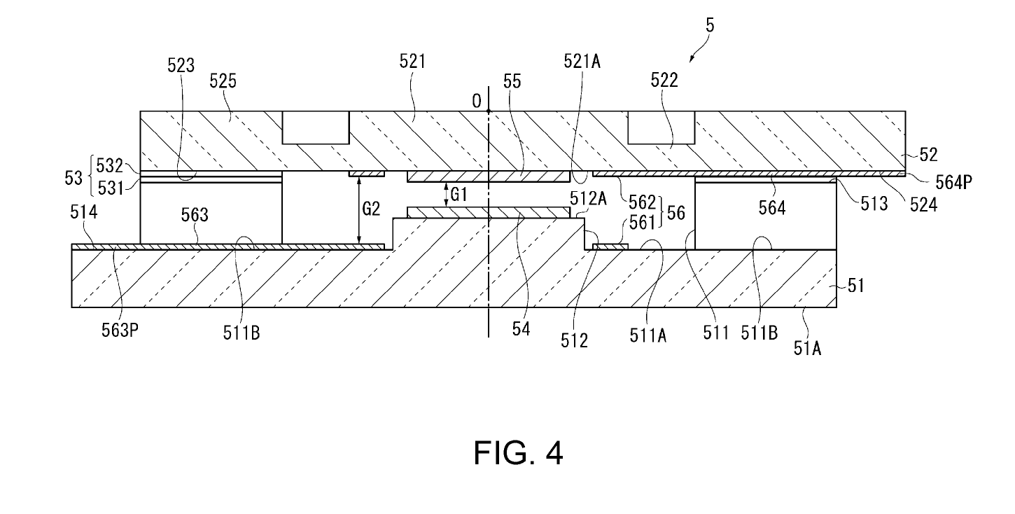

FIG. 3 is a plan view showing the schematic configuration of the wavelength tunable interference filter 5 housed in the housing 610, and FIG. 4 is a cross-sectional view taken along the line IV-IV of FIG. 3 and shows the schematic configuration of the wavelength tunable interference filter 5.

As shown in FIG. 3, the wavelength tunable interference filter 5 includes a fixed substrate 51 and a movable substrate 52 corresponding to a substrate according to the invention. Each of the fixed substrate 51 and the movable substrate 52 is formed of various kinds of glass, such as soda glass, crystalline glass, quartz glass, lead glass, potassium glass, borosilicate glass, and alkali-free glass, and crystal, for example. As shown in FIG. 4, the fixed substrate 51 and the movable substrate 52 are integrally formed by being bonded to each other through a bonding film 53 (first and second bonding films 531 and 532). Specifically, a first bonding portion 513 of the fixed substrate 51 and a second bonding portion 523 of the movable substrate 52 are bonded to each other through the bonding film 53 that is formed of a plasma-polymerized film containing siloxane as a main component, for example.

In the following description, a plan view when viewed from the substrate thickness direction of the fixed substrate 51 or the movable substrate 52, that is, a plan view when the wavelength tunable interference filter 5 is viewed from the lamination direction of the fixed substrate 51, the bonding film 53, and the movable substrate 52 is referred to as a filter plan view.

As shown in FIG. 4, a fixed reflective film 54 that forms one of a pair of reflective films according to the invention is provided on the fixed substrate 51. A movable reflective film 55 that forms the other one of the pair of reflective films according to the invention is provided on the movable substrate 52. The fixed reflective film 54 and the movable reflective film 55 are disposed so as to face each other with an inter-reflective film gap G1 interposed therebetween.

In addition, an electrostatic actuator 56 used to adjust the size of the inter-reflective film gap G1 is provided in the wavelength tunable interference filter 5. This electrostatic actuator 56 includes a fixed electrode 561 provided on the fixed substrate 51 and a movable electrode 562 provided on the movable substrate 52, and is formed such that the electrodes 561 and 562 face each other. The fixed electrode 561 and the movable electrode 562 face each other with an inter-electrode gap interposed therebetween. Here, the electrodes 561 and 562 may be directly provided on the surfaces of the fixed substrate 51 and the movable substrate 52, or may be provided with another film member interposed therebetween.

In the present embodiment, the configuration is exemplified in which the inter-reflective film gap G1 is formed so as to be smaller than the inter-electrode gap. For example, depending on a wavelength range to be transmitted by the wavelength tunable interference filter 5, the inter-reflective film gap G1 may be formed so as to be larger than the inter-electrode gap.

In filter plan view, a side C1-C2 of the fixed substrate 51 protrudes outward from a side C1′-C2′ of the movable substrate 52, and forms a fixed side electrical portion 514. In addition, a side C3′-C4′ of the movable substrate 52 protrudes outward from a side C3-C4 of the fixed substrate 51, and forms a movable side electrical portion 524.

### Configuration of Fixed Substrate

In the fixed substrate 51, an electrode arrangement groove 511 and a reflective film arrangement portion 512 are formed by etching. The fixed substrate 51 is formed in a larger thickness than the movable substrate 52. Accordingly, there is no bending of the fixed substrate 51 due to the internal stress of the fixed electrode 561 or electrostatic attraction when applying a voltage between the fixed electrode 561 and the movable electrode 562.

The electrode arrangement groove 511 is formed in an annular shape, which has a filter center point O of the fixed substrate 51 as its center, in filter plan view. The reflective film arrangement portion 512 is formed so as to protrude from the center of the electrode arrangement groove 511 to the movable substrate 52 side in the plan view. The groove bottom surface of the electrode arrangement groove 511 is an electrode arrangement surface 511A on which the fixed electrode 561 is disposed. The protruding distal surface of the reflective film arrangement portion 512 is a reflective film arrangement surface 512A.

On the fixed substrate 51, a connection electrode groove 511B is provided in a region from the electrode arrangement groove 511 to the fixed side electrical portion 514 and a region from the electrode arrangement groove 511 to the side C3-C4. In the present embodiment, the electrode arrangement surface 511A, the bottom portion of the connection electrode groove 511B, and the surface of the fixed side electrical portion 514 are the same plane.

The fixed electrode 561 that forms the electrostatic actuator 56 is provided on the electrode arrangement surface 511A. More specifically, the fixed electrode 561 is provided in a region of the electrode arrangement surface 511A facing the movable electrode 562 of a movable portion 521 to be described later. In addition, an insulating film for ensuring the insulation between the fixed electrode 561 and the movable electrode 562 may be laminated on the fixed electrode 561.

A fixed connection electrode 563 connected to the outer peripheral edge of the fixed electrode 561 is provided on the fixed substrate 51. The fixed connection electrode 563 is provided over the fixed side electrical portion 514 and the connection electrode groove 511B toward the fixed side electrical portion 514 from the electrode arrangement groove 511. The fixed connection electrode 563 forms a fixed electrode pad 563P, which is electrically connected to an inside terminal portion to be described later, in the fixed side electrical portion 514.

In addition, although the configuration in which one fixed electrode 561 is provided on the electrode arrangement surface 511A is shown in the present embodiment, it is possible to adopt a configuration (double electrode configuration) in which two electrodes as concentric circles having the filter center point O as their center are provided, for example. In addition, a configuration may be adopted in which a transparent electrode is provided on the fixed reflective film 54, or a connection electrode may be formed in the fixed side electrical portion 514 from the fixed reflective film 54 using a conductive fixed reflective film 54. In this case, a part of the fixed electrode 561 may be notched according to the position of the connection electrode.

As described above, the reflective film arrangement portion 512 is formed in an approximately cylindrical shape, which has a smaller diameter than the electrode arrangement groove 511, on the same axis as the electrode arrangement groove 511, and includes the reflective film arrangement surface 512A facing the movable substrate 52 of the reflective film arrangement portion 512.

As shown in FIG. 4, the fixed reflective film 54 is provided in the reflective film arrangement portion 512. As the fixed reflective film 54, it is possible to use a metal film, such as Ag, and an alloy film, such as an Ag alloy, for example. In addition, it is also possible to use a dielectric multilayer film having a high refractive layer of TiO₂ and a low refractive layer of SiO₂, for example. In addition, it is also possible to use a reflective film in which a metal film (or an alloy film) is laminated on a dielectric multilayer film, a reflective film in which a dielectric multilayer film is laminated on a metal film (or an alloy film), a reflective film in which a single refractive layer (for example, TiO₂ or SiO₂) and a metal film (or an alloy film) are laminated, and the like.

On the light incidence surface (surface on which the fixed reflective film 54 is not provided) of the fixed substrate 51, an anti-reflection film may be formed at a position corresponding to the fixed reflective film 54. The anti-reflection film can be formed by laminating a low refractive index film and a high refractive index film alternately, and reduces the reflectance of visible light on the surface of the fixed substrate 51. As a result, the transmittance is increased.

In addition, a portion of the surface of the fixed substrate 51 facing the movable substrate 52, on which the electrode arrangement groove 511, the reflective film arrangement portion 512, and the connection electrode groove 511B are not formed by etching, forms the first bonding portion 513. The first bonding film 531 is provided in the first bonding portion 513, and the first bonding film 531 is bonded to the second bonding film 532 provided on the movable substrate 52. Thus, the fixed substrate 51 and the movable substrate 52 are bonded to each other, as described above.

### Configuration of Movable Substrate

The movable substrate 52 includes the movable portion 521, which is formed in a circular shape having a filter center point O as its center, and a holding portion 522, which is coaxial with the movable portion 521 and holds the movable portion 521.

The movable portion 521 is formed in a larger thickness than the holding portion 522. The movable portion 521 is formed so as to have a larger diameter than at least the diameter of the outer peripheral edge of the reflective film arrangement surface 512A in filter plan view. The movable electrode 562 and the movable reflective film 55 are provided in the movable portion 521.

Similar to the fixed substrate 51, an anti-reflection film may be formed on a surface of the movable portion 521 not facing the fixed substrate 51. The anti-reflection film can be formed by laminating a low refractive index film and a high refractive index film alternately, and reduces the reflectance of visible light on the surface of the movable substrate 52. As a result, the transmittance can be increased.

The movable electrode 562 faces the fixed electrode 561 with a gap G2 interposed therebetween, and is formed in an annular shape that is the same shape as the fixed electrode 561. The fixed electrode 561 and the movable electrode 562 form the electrostatic actuator 56. A movable connection electrode 564 connected to the outer peripheral edge of the movable electrode 562 is provided on the movable substrate 52. The movable connection electrode 564 is provided from the movable portion 521 to the movable side electrical portion 524 so as to face the connection electrode groove 511B provided on the side C3-C4 of the fixed substrate 51, and forms a movable electrode pad 564P, which is electrically connected to an inside terminal portion, in the movable side electrical portion 524.

The movable reflective film 55 is provided in the center of the movable surface 521A of the movable portion 521 so as to face the fixed reflective film 54 with the gap G1 interposed therebetween. As the movable reflective film 55 described above, a reflective film having the same configuration as the fixed reflective film 54 is used.

Although the example where the gap G2 is larger than the gap G1 is shown as described above in the present embodiment, the invention is not limited thereto. For example, when infrared light or far-infrared light is used as measurement target light, the gap G1 may be larger than the gap G2 according to the wavelength band of the measurement target light.

The holding portion 522 is a diaphragm surrounding the periphery of the movable portion 521, and is formed in a smaller thickness than the movable portion 521. The holding portion 522 bends more easily than the movable portion 521 does. Accordingly, it is possible to displace the movable portion 521 to the fixed substrate 51 side by slight electrostatic attraction. In this case, since the movable portion 521 is thicker than the holding portion 522, the rigidity of the movable portion 521 is large. Therefore, even if the holding portion 522 is pulled to the fixed substrate 51 side due to electrostatic attraction, no change in the shape of the movable portion 521 is caused. Accordingly, since the bending of the movable reflective film 55 provided in the movable portion 521 does not occur either, it is possible to maintain the fixed reflective film 54 and the movable reflective film 55 in a parallel state continuously.

In addition, although the diaphragm-like holding portion 522 is exemplified in the present embodiment, the invention is not limited thereto. For example, beam-shaped holding portions, which are disposed at equal angular intervals around the filter center point O, may also be provided.

In the movable substrate 52, a region facing the first bonding portion 513 is the second bonding portion 523. The second bonding film 532 is provided in the second bonding portion 523, and the second bonding film 532 is bonded to the first bonding film 531 as described above. Thus, the fixed substrate 51 and the movable substrate 52 are bonded to each other.

### Configuration of Housing

As shown in FIGS. 1 and 2, the housing 610 includes a base 620 corresponding to a second member according to the invention and a lid 630 corresponding to a first member according to the invention. The base 620 and the lid 630 are bonded to each other to form a receiving space therebetween, and the wavelength tunable interference filter 5 is housed in the receiving space.

### Configuration of Base

The base 620 is formed of ceramic, for example. The base 620 includes a pedestal portion 621 and a side wall portion 622.

The pedestal portion 621 is formed, for example, in a flat plate shape having a rectangular outer shape in filter plan view, and the side wall portion 622 rises toward the lid 630 from the outer periphery of the pedestal portion 621.

The pedestal portion 621 includes a first opening 623 passing therethrough in the thickness direction. The first opening 623 is provided so as to include a region, which overlaps the reflective films 54 and 55, in plan view when viewed from a normal direction with respect to the opening surface of the first opening 623 in a state where the wavelength tunable interference filter 5 is housed in the pedestal portion 621.

A first glass member 627 that covers the first opening 623 is bonded to the surface (base outside surface 621B) of the pedestal portion 621 not facing the lid 630. In order to bond the pedestal portion 621 and the first glass member 627 to each other, it is possible to use low melting point glass bonding using a glass frit (low melting point glass) which is a piece of glass obtained by dissolving a glass material at high temperature and quenching the glass material, bonding using an epoxy resin, and the like. In the present embodiment, the receiving space is hermetically maintained in a state where the inside of the receiving space is maintained in a decompressed state. Accordingly, it is preferable to bond the pedestal portion 621 and the first glass member 627 to each other by low melting point glass bonding.

An inside terminal portion 624 connected to the electrode pads 563P and 564P of the wavelength tunable interference filter 5 is provided on the inside surface (base inside surface 621A) of the pedestal portion 621 facing the lid 630. The inside terminal portion 624 and each of the electrode pads 563P and 564P are connected to each other through a wire, such as Au, by wire bonding, for example. Although wire bonding is exemplified in the present embodiment, for example, a flexible printed circuit (FPC) may be used.

In the pedestal portion 621, a through hole 625 is formed at a position where the inside terminal portion 624 is provided. The inside terminal portion 624 is connected to an outside terminal portion 626, which is provided on the base outside surface 621B of the pedestal portion 621, through the through hole 625.

The side wall portion 622 rises from the edge of the pedestal portion 621, and covers the periphery of the wavelength tunable interference filter 5 placed on the base inside surface 621A. The surface (bonding end surface 622A) of the side wall portion 622 facing the lid 630 is a flat surface parallel to the base inside surface 621A, for example.

The wavelength tunable interference filter 5 is fixed to the base 620, for example, using a fixing material, such as an adhesive. In this case, the wavelength tunable interference filter 5 may be fixed to the side wall portion 622, or may be fixed to the pedestal portion 621. A fixing material may be provided at a plurality of places. However, in order to suppress the stress of the fixing material from being transmitted to the wavelength tunable interference filter 5, it is preferable to fix the wavelength tunable interference filter 5 at one place.

### Configuration of Lid

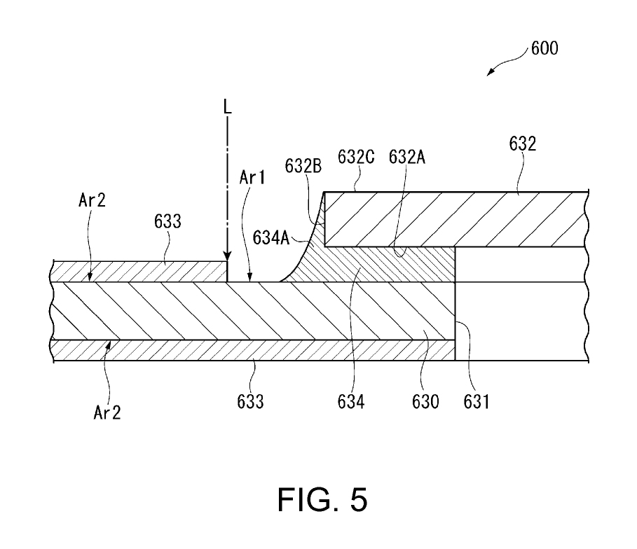

FIG. 5 is an enlarged cross-sectional view of a part of the lid 630.

The lid 630 is a plate-shaped member having a rectangular shape, which is the same as the pedestal portion 621, in plan view when viewed from the thickness direction of the lid 630. The lid 630 can be formed of, for example, an alloy, such as Kovar, or metal. In the present embodiment, the lid 630 is formed of Kovar.

As shown in FIGS. 1 and 2, the lid 630 has a second opening 631 (corresponding to an opening according to the invention) passing therethrough in the thickness direction of the lid 630. The second opening 631 is provided so as to include a region, which overlaps the reflective films 54 and 55, in plan view when viewed from a normal direction with respect to the opening surface of the second opening 631 in a state where the wavelength tunable interference filter 5 is placed in the base 620.

On the outer peripheral surface of the lid 630, a second glass member 632 (corresponding to a light transmissive member according to the invention) is bonded so as to cover the second opening 631.

A metal layer 633 is coated and formed on the surface of the lid 630. The metal layer 633 can be formed using a plating method.

In FIG. 1, a line L is a virtual line that is separated from the outer peripheral edge of the second glass member 632 outward (toward a side away from the second opening 631) by a predetermined distance and is disposed along the outer peripheral edge of the second glass member 632 in plan view when the lid 30 is viewed from a normal direction with respect to the opening surface of the second opening 631 in a state where the second glass member 632 is bonded to the lid 630. In the present embodiment, in a region (first region Ar1) from the line L to the second opening 631, the second glass member 632 is bonded to the lid 630. In the first region Ar1, the metal layer 633 is not provided. The metal layer 633 is provided in a region (second region Ar2) other than the first region Ar1. Preferably, the metal layer 633 is provided in the entire second region Ar2.

Here, it is preferable that the metal layer 633 cover the lid 630 as much as possible. Therefore, it is preferable that the distance (the predetermined distance) between the line L and the outer peripheral edge of the second glass member 632 be as small as possible (the line L is located as close to the outer peripheral edge of the second glass member 632 as possible) and be a distance, which does not allow the metal layer 633 and low melting point glass 634 to be in contact with each other, even if the fillet of the low melting point glass 634 is formed when bonding the second glass member 632 using the low melting point glass 634. That is, the line L is set at a position closest to the outer peripheral edge of the second glass member 632 to the extent that the line L is not in contact with the fillet of the low melting point glass.

The second glass member 632 is bonded to the lid 630 in the first region Ar1 through the low melting point glass 634.

As shown in FIG. 5, the low melting point glass 634 is in contact with a portion of the second glass member 632 from a facing surface 632A of the second glass member 632, which faces the lid 630, to a side surface 632B (surface perpendicular to the facing surface 632A) along the outer peripheral edge of the second glass member 632. That is, in the first region Ar1, a fillet 634A of the low melting point glass 634 is provided over the outer peripheral edge of the second glass member 632.

As described above, since the metal layer 633 is provided in the second region Ar2, the low melting point glass 634 provided in the first region Ar1 does not come in contact with the metal layer 633.

As described above, the metal layer 633 is provided so as to cover the second region Ar2. As the metal layer 633, a material having a high adhesion property for the lid 630 is selected. In the present embodiment, the metal layer 633 containing nickel is used for the lid 630 formed of Kovar.

The lid 630 is bonded to the bonding end surface 622A of the base 620. For this bonding, for example, not only bonding based on metal brazing but also seam, laser welding, and the like can be used. In this case, since the base 620 and the lid 630 are bonded to each other, the receiving space in which the wavelength tunable interference filter 5 is housed is hermetically sealed.

### Manufacturing of Optical Filter Device

A method of manufacturing the optical filter device 600 will be described.

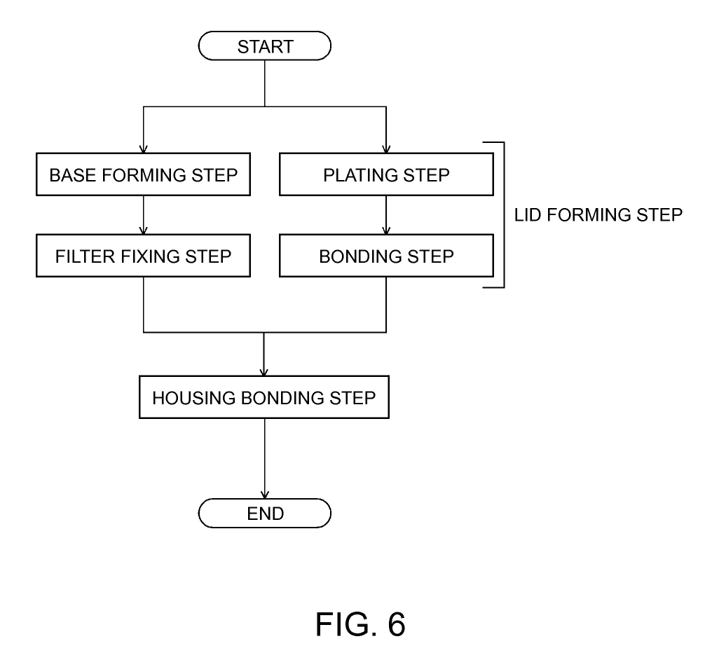

FIG. 6 is a flowchart showing the process of manufacturing the housing 610 of the optical filter device 600 of the present embodiment.

As shown in FIG. 6, in the present embodiment, the housing 610 of the optical filter device 600 is manufactured by a base forming step, a filter fixing step, a lid forming step, and a housing bonding step.

In the base forming step, a ceramic sheet in which the first opening 623 and the through hole 625 are formed is laminated, a ceramic sheet corresponding to the side wall portion 622 is laminated, and these are baked. As a result, the basic shape of the base 620 including the pedestal portion 621 and the side wall portion 622 is formed.

Then, the through hole 625 is embedded using a conductive member (for example, metal paste), the inside terminal portion 624 is formed on the base inside surface 621A of the pedestal portion 621, and the outside terminal portion 626 is formed on the base outside surface 621B. As a result, airtightness in the through hole 625 is maintained.

Then, the first glass member 627 that covers the first opening 623 is bonded to the base outside surface 621B through low melting point glass.

In the filter fixing step, a fixing material, such as an adhesive, is applied onto the base inside surface 621A of the base 620 or the side wall portion 622. Then, the wavelength tunable interference filter 5 is fixed by a fixing material while performing alignment so that the reflective films 54 and 55 of the wavelength tunable interference filter 5 are disposed in the opening region of the first opening 623. In this case, by fixing the fixed substrate 51 of the wavelength tunable interference filter 5 with the fixing material, it is possible to suppress the inclination of the movable portion 521 and the like due to the stress of the fixing material.

Then, each of the electrode pads 563P and 564P of the wavelength tunable interference filter 5 and the inside terminal portion 624 of the base 620 are connected to each other by wire bonding.

In the lid forming step, first, the metal layer 633 is formed on the lid 630 formed of Kovar, in which the second opening 631 is provided, using a plating method (plating step).

In this case, in the lid 630, the metal layer 633 is formed in the second region Ar2 other than the first region Ar1 from the line L to the opening edge of the second opening 631. Specifically, the metal layer 633 is applied onto the entire surface of the lid 630 after masking the first region Ar1 of the lid 630, and then the mask is removed.

The plating method is not limited to this. For example, only the metal layer 633 of the first region Ar1 may be removed by etching, polishing, or the like after forming the metal layer 633 on the entire surface of the lid 630.

Then, the low melting point glass 634 in a molten state is provided on the surface of the lid 630 facing the second glass member 632 of the first region Ar1, and is bonded to the second glass member 632 (bonding step).

In this case, by pressing the second glass member 632 against the lid 630 side, the low melting point glass 634 protrudes outward from the outer peripheral edge of the second glass member 632 (in the first region Ar1) and rises along the side surface 632B, and the fillet 634A is formed.

As described above, the lid 630 is formed.

In the housing bonding step, the base 620 and the lid 630 are bonded to each other. For example, bonding between the base 620 and the lid 630 is performed by the seam under the environment set as a vacuum atmosphere by a vacuum chamber device or the like. As the bonding method, it is possible to use various bonding methods, such as bonding based on metal brazing and laser welding, as described above.

As described above, the optical filter device 600 is manufactured.

### Operations and Effects of First Embodiment

In the present embodiment, the metal layer 633 is not provided in the first region Ar1 on the surface of the lid 630, and the metal layer 633 is provided in the second region Ar2. For this reason, when bonding the second glass member 632 to the lid 630 through the low melting point glass 634, even if the fillet 634A of the low melting point glass 634 is formed along the outer peripheral edge of the second glass member 632, the metal layer 633 and the low melting point glass 634 do not come in contact with each other. Therefore, deterioration or cracking of the metal layer 633, cracking of the low melting point glass 634, and the like due to contact between the low melting point glass 634 and the metal layer 633 do not occur.

In addition, since the fillet 634A is formed at the time of bonding using the low melting point glass 634, the bonding strength between the lid 630 and the second glass member 632 can be further increased, and airtightness can also be increased. Therefore, it is possible to maintain the airtightness of the receiving space formed by the base 620 and the lid 630.

In the present embodiment, the wavelength tunable interference filter 5 is housed in the receiving space.

When driving the wavelength tunable interference filter 5 by applying a voltage to the electrostatic actuator 56, if air is present between the reflective films 54 and 55, the responsiveness of the wavelength tunable interference filter 5 is reduced. When the reflective films 54 and 55 are metal films, there is a problem, such as oxidation. In contrast, in the present embodiment, since the airtightness inside the housing 610 is high as described above, it is possible to maintain the vacuum state for a long period of time. Therefore, it is possible to suppress a reduction in the driving responsiveness of the wavelength tunable interference filter 5 and to suppress the deterioration of the reflective films 54 and 55.

### Second Embodiment

Next, a second embodiment of the invention will be described with reference to the diagrams.

In the first embodiment described above, only the low melting point glass 634 is used to bond the lid 630 and the second glass member 632 to each other. In contrast, the present embodiment is different from the first embodiment in that a resin member is further used.

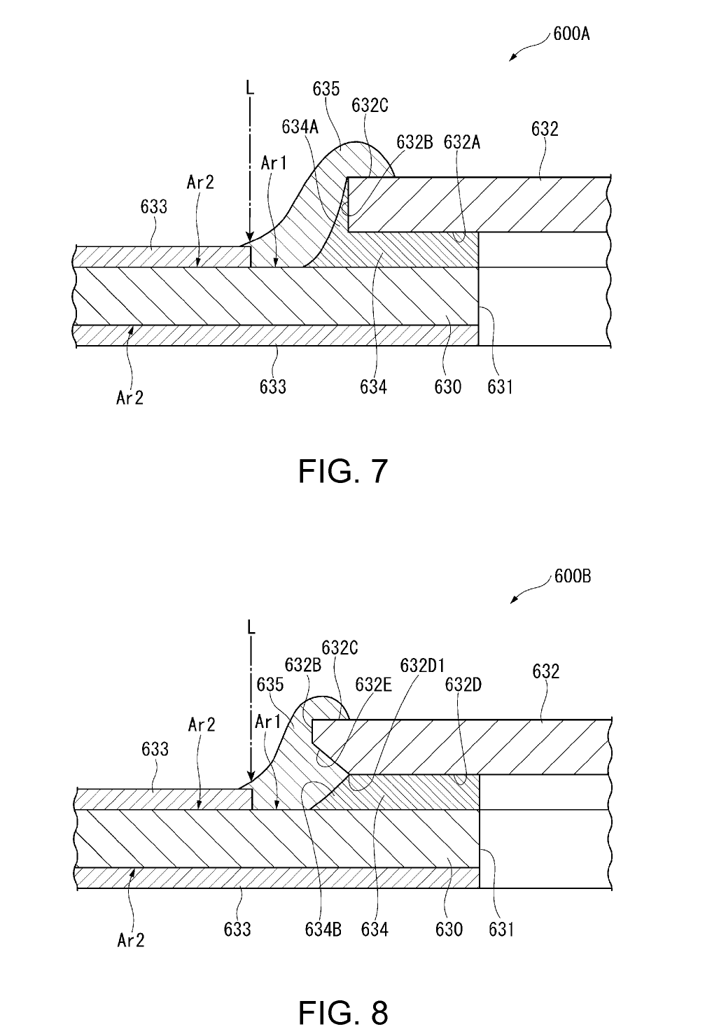

FIG. 7 is an enlarged cross-sectional view of a part of a lid 630 in an optical filter device 600A of the second embodiment. In explaining the subsequent embodiments, the same components as in the embodiments described above are denoted by the same reference numerals, and explanation thereof will be omitted or simplified.

In the optical filter device 600A of the present embodiment, as shown in FIG. 7, a bonding portion between the lid 630 and the second glass member 632 is covered by further using a resin adhesive (resin member 635), thereby improving the bonding strength.

Specifically, the resin member 635 covers a region from an outer peripheral portion of a top surface 632C of the second glass member 632 to the surface of the fillet 634A of the low melting point glass 634 and the first region Ar1 of the lid 630. Accordingly, the lid 630 is covered by the metal layer 633 in the second region Ar2, and is covered by the low melting point glass 634 or the resin member 635 in the first region Ar1. In this case, as shown in FIG. 7, the peeling of the metal layer 633 can be suppressed by covering the end of the metal layer 633 along the line L using the resin member 635.

### Operations and Effects of Second Embodiment

In the present embodiment, a surface of the low melting point glass 634 (surface of the fillet 634A) that is not in contact with the second glass member 632 and the lid 630 is covered by the resin member 635. Therefore, it is possible to further improve the airtightness of the bonding of the low melting point glass 634.

The resin member 635 covers from the top surface of the second glass member 632 to the first region Ar1 of the lid 630. Therefore, since the second glass member 632 is biased to the lid 630 side by the contraction force during the curing of the resin member 635, it is possible to increase the bonding strength.

Furthermore, the resin member 635 covers the first region Ar1. That is, the surface of the lid 630 is covered by any of the metal layer 633, the low melting point glass 634, and the resin member 635. Therefore, it is possible to increase the corrosion resistance of the lid 630.

### Third Embodiment

Next, a third embodiment of the invention will be described with reference to the diagrams.

In the second embodiment described above, the example is illustrated in which the fillet 634A is formed from the side surface 632B of the second glass member 632 and the surface of the fillet 634A is covered by the resin member 635. In contrast, in the third embodiment, it is possible to further improve the bonding strength by providing the resin member 635 between the second glass member 632 and the lid 630.

FIG. 8 is an enlarged cross-sectional view of a part of a lid 630 in an optical filter device 600B of the third embodiment.

As shown in FIG. 8, in the first region Ar1, the second glass member 632 of the present embodiment is configured to include a facing surface 632D (flat surface portion) that faces the lid 630, an inclined surface 632E (inclined surface portion) that is continuous with an end 632D1 of the facing surface 632D and is inclined in a direction away from the lid 630 toward the outer peripheral edge of the second glass member 632, a side surface 632B, and a top surface 632C.

As shown in FIG. 8, the low melting point glass 634 is provided between the facing surface 632D and the lid 630, forms a fillet 634B toward the outside from the end 632D1, and bonds the lid 630 and the second glass member 632 to each other. That is, a gap is formed between the inclined surface 632E of the second glass member 632 and the lid 630.

The resin member 635 of the present embodiment covers a region from an outer peripheral portion of the top surface 632C of the second glass member 632 to the side surface 632B, the inclined surface 632E, the surface of the fillet 634B of the low melting point glass 634, and the first region Ar1 of the lid 630.

That is, the resin member 635 is provided in a region, in which the low melting point glass 634 is not provided, between the second glass member 632 and the lid 630.

### Operations and Effects of Third Embodiment

In the present embodiment, the inclined surface 632E is interposed between the resin member 635 and the top surface 632C of the second glass member 632, and a biasing force that biases the second glass member 632 to the lid 630 side is increased by the contraction force at the time of resin curing. Therefore, compared with the second embodiment, it is possible to obtain stronger bonding strength and higher airtightness.

### Bonding Strength in Each Embodiment

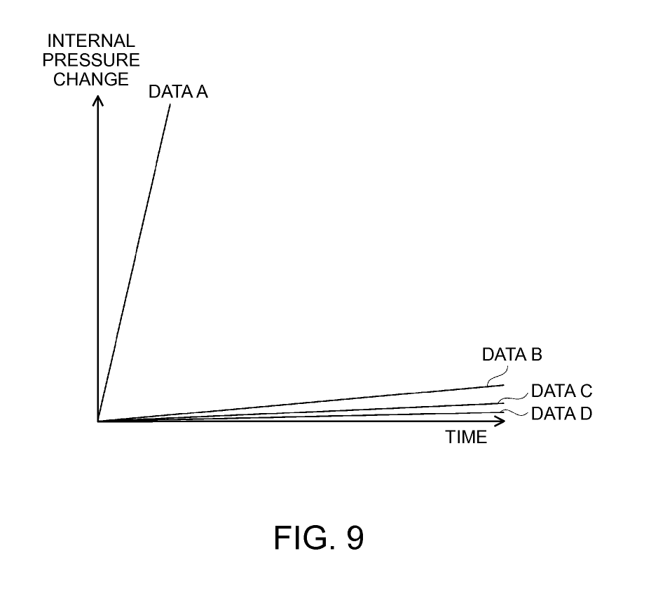

FIG. 9 is a diagram showing a change in the internal pressure of each of the optical filter devices 600, 600A, and 600B in the embodiments described above. In FIG. 9, data A shows a change in the internal pressure of an optical filter device that is obtained by forming a metal layer on the entire surface of the lid and then bonding the second glass member to the metal layer through low melting point glass. Data B shows a change in the internal pressure of the optical filter device 600 of the first embodiment, data C shows a change in the internal pressure of the optical filter device 600A of the second embodiment, and data D shows a change in the internal pressure of the optical filter device 600B of the third embodiment.

As shown in FIG. 9, when a metal layer is formed on the entire surface of the lid using a plating method and the second glass member is bonded to the metal layer through the low melting point glass, cracking occurs in the metal layer. Due to the cracking, airtightness is significantly reduced. For this reason, the internal pressure changed at a rate of 10 Pa/day over time. In contrast, the amount of change in the internal pressure was 0.2 Pa/day in the optical filter device 600, 0.1 Pa/day in the optical filter device 600A, and 0.05 Pa/day in the optical filter device 600B, and airtightness was maintained satisfactorily.

### Fourth Embodiment

Next, a fourth embodiment of the invention will be described with reference to the accompanying diagrams.

In the fourth embodiment, a colorimetric sensor 3, which is an optical module in which the optical filter device 600 of the first embodiment is provided, and a colorimetric apparatus 1, which is an electronic apparatus in which the optical filter device 600 is provided, will be described. Instead of the optical filter device 600, the optical filter devices 600A and 600B of the second and third embodiments may also be provided.

### Schematic Configuration of Colorimetric Apparatus

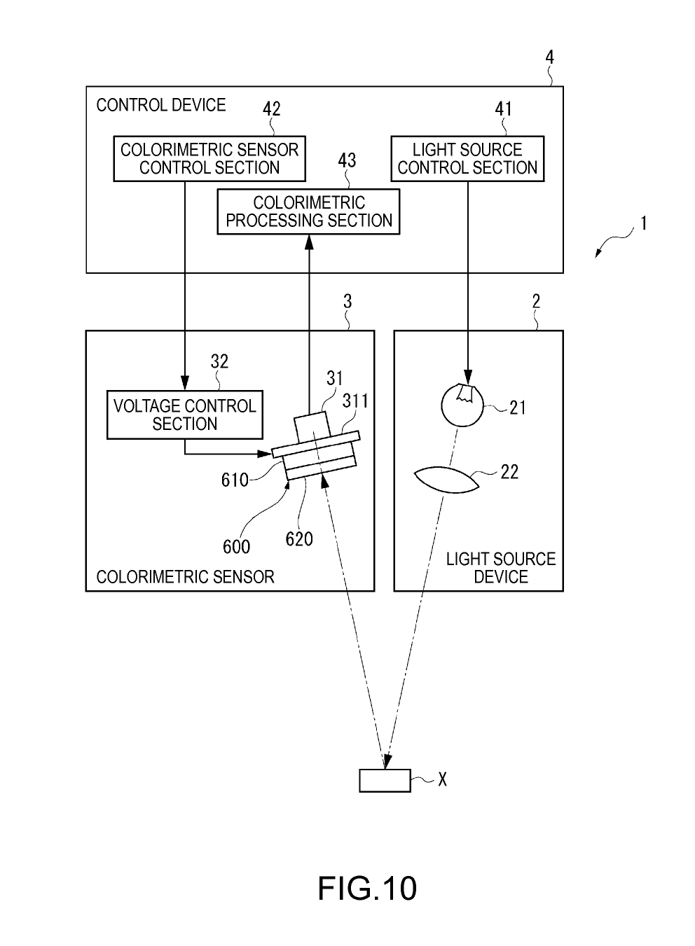

FIG. 10 is a block diagram showing the schematic configuration of the colorimetric apparatus 1.

The colorimetric apparatus 1 is an electronic apparatus according to the invention. As shown in FIG. 10, the colorimetric apparatus 1 includes a light source device 2 that emits light to a test target X, the colorimetric sensor 3 (optical module), and a control device 4 that controls the overall operation of the colorimetric apparatus 1. The colorimetric apparatus 1 receives test target light, which is emitted from the light source device 2 and is reflected by the test target X, using the colorimetric sensor 3. In addition, the colorimetric apparatus 1 is an apparatus that analyzes and measures the chromaticity of the test target light, that is, the color of the test target X, based on a detection signal output from the colorimetric sensor 3 that has received the test target light.

### Configuration of Light Source Device

The light source device 2 includes a light source 21 and a plurality of lenses 22 (only one lens is shown in FIG. 10), and emits white light to the test target X. A collimator lens may be included in the plurality of lenses 22. In this case, the light source device 2 forms the white light emitted from the light source 21 as parallel light using the collimator lens and emits the parallel light from a projection lens (not shown) toward the test target X. Although the colorimetric apparatus 1 including the light source device 2 is exemplified in the present embodiment, the light source device 2 may not be provided, for example, when the test target X is a light emitting member, such as a liquid crystal panel.

### Configuration of Colorimetric Sensor

The colorimetric sensor 3 forms the optical module according to the invention, and includes the optical filter device 600 of the first embodiment described above. As shown in FIG. 10, the colorimetric sensor 3 includes the optical filter device 600, a detection section 31 that receives light transmitted through the optical filter device 600, and a voltage control section 32 that changes the wavelength of light transmitted through the wavelength tunable interference filter 5.

In addition, the colorimetric sensor 3 includes an incident optical lens (not shown) that is provided at a position facing the wavelength tunable interference filter 5 and that guides reflected light (test target light), which is reflected by the test target X, to the inside. The colorimetric sensor 3 separates light having a predetermined wavelength, from the test target light incident from the incident optical lens, using the wavelength tunable interference filter 5 in the optical filter device 600, and receives the separated light using the detection section 31.

The detection section 31 is formed by a plurality of photoelectric conversion elements, and generates an electrical signal corresponding to the amount of received light. The detection section 31 is connected to the control device 4, for example, through a circuit board 311, and outputs the generated electrical signal to the control device 4 as a light receiving signal.

In addition, the outside terminal portion 626 formed on the base outside surface 621B of the housing 610 is connected to the circuit board 311. The outside terminal portion 626 is connected to the voltage control section 32 through a circuit formed on the circuit board 311.

In such a configuration, the optical filter device 600 and the detection section 31 can be integrally formed through the circuit board 311. Therefore, the configuration of the colorimetric sensor 3 can be simplified.

The voltage control section 32 is connected to the outside terminal portion 626 of the optical filter device 600 through the circuit board 311. The voltage control section drives the electrostatic actuator 56 by applying a predetermined step voltage between the fixed electrode pad 563P and the movable electrode pad 564P based on the control signal input from the control device 4. Then, electrostatic attraction occurs in the inter-electrode gap, and the holding portion 522 is bent. Accordingly, since the movable portion 521 is displaced to the fixed substrate 51 side, it is possible to set the inter-reflective film gap G1 to a desired size.

### Configuration of Control Device

The control device 4 controls the overall operation of the colorimetric apparatus 1.

As the control device 4, for example, a general-purpose personal computer, a personal digital assistant, and a computer dedicated to color measurement can be used.

In addition, as shown in FIG. 10, the control device 4 is configured to include a light source control section 41, a colorimetric sensor control section 42, and a colorimetric processing section 43.

The light source control section 41 is connected to the light source device 2. In addition, the light source control section 41 outputs a predetermined control signal to the light source device 2, for example, based on setting input from the user and emits white light with predetermined brightness from the light source device 2.

The colorimetric sensor control section 42 is connected to the colorimetric sensor 3. In addition, the colorimetric sensor control section 42 sets the wavelength of light received by the colorimetric sensor 3, for example, based on a setting input from the user and outputs to the colorimetric sensor 3 a control signal indicating the detection of the amount of received light with the wavelength. Then, the voltage control section 32 of the colorimetric sensor 3 sets a voltage, which is applied to the electrostatic actuator 56, based on the output control signal such that only light with a wavelength that the user desires is transmitted.

The colorimetric processing section 43 analyzes the chromaticity of the test target X from the amount of received light detected by the detection section 31.

### Operations and Effects of Fourth Embodiment

The colorimetric apparatus 1 of the present embodiment includes the optical filter device 600 described in the first embodiment. As described above, the optical filter device 600 has high airtightness in the receiving space, and can suppress a change in the internal pressure. Therefore, since the installation environment of the wavelength tunable interference filter 5 can be maintained in a decompressed state, it is possible to maintain high responsiveness when driving the wavelength tunable interference filter 5. In addition, since the deterioration of the reflective films 54 and 55 can be suppressed, it is also possible to suppress a reduction in resolution.

Therefore, also in the colorimetric sensor 3 and the colorimetric apparatus 1 including the optical filter device 600 described above, it is possible to suppress performance degradation. As a result, since light having a target wavelength extracted with high resolution can be detected for a long period of time, it is possible to perform accurate color analysis processing.

### Modifications of Embodiments

The invention is not limited to the embodiments described above, and various modifications or improvements may be made without departing from the scope and spirit of the invention.

For example, although the example where the metal layer 633 is provided in the entire second region Ar2 of the lid 630 is illustrated in each of the embodiments described above, the invention is not limited thereto. For example, the metal layer 633 may be provided in a part of the second region Ar2.

In the embodiment described above, the first member is the lid 630, and the second member is the base 620. However, the invention is not limited to this. For example, the first member may be a base on which an optical element is provided, and may be formed of metal or an alloy, such as Kovar. In this case, the first glass member that blocks the first opening provided in the first member becomes a light transmissive member, and the invention can be applied in the bonding.

In the embodiment described above, the example is illustrated in which the lid 630 as the first member is formed of Kovar, the second glass member 632 as a light transmissive member is formed of glass, and the metal layer 633 is formed of nickel using a plating method. However, the invention is not limited to the example. As the light transmissive member and the first member, it is possible to appropriately select and use materials having approximately the same thermal expansion coefficient. As the metal, it is possible to appropriately select and use a metal having good adhesion to the first member.

For example, when infrared light is used as light to be analyzed, silicon allowing infrared light to be transmitted therethrough may be used as the light transmissive member. The lid 630, which is the first member, may be formed of, for example, an alloy or aluminum as well as Kovar. As the metal layer 633, for example, zinc according to the plating method may be used, in addition to the nickel according to the plating method.

In the embodiment described above, the example is illustrated in which the lid 630 as the first member and the second glass member 632 as a light transmissive member are bonded to each other through the low melting point glass. However, the invention is not limited to the example. For example, the first member and the light transmissive member may also be bonded to each other through a bonding material, such as an epoxy resin. As the bonding material, it is preferable to select a material having approximately the same thermal expansion coefficient as the first member or the light transmissive member.

In the third embodiment, the configuration has been exemplified in which the second glass member 632 has the planar inclined surface 632E that is continuous with the end 632D1 of the facing surface 632D. However, the invention is not limited to the configuration. For example, the inclined surface 632E may be a curved surface, or may have a plurality of inclined surfaces 632E. Alternatively, for example, a plurality of flat surfaces, which are parallel to the facing surface 632D and have different distances from the lid 630, may be provided in a stepped shape. In all of the configurations, the resin member 635 can be filled between the second glass member 632 and the lid 630. As a result, it is possible to improve bonding strength and airtightness.

In each of the embodiments described above, the configuration has been exemplified in which the second glass member 632, which is a light transmissive member, has a rectangular shape in plan view when viewed from the normal direction with respect to the opening surface of the second opening 631. However, the shape of the second glass member 632 is not limited to the rectangular shape. For example, the second glass member 632 may be formed in other shapes, such as a circular shape or a polygonal shape, and any shape that can cover the second opening 631 may be used. The second opening 631 is not limited to being formed in a rectangular shape either, and may be formed in other shapes, such as a circular shape or a polygonal shape.

In addition, the virtual line L may be set according to the shape of the second glass member 632. For example, the virtual line L may include a curve.

Although the wavelength tunable interference filter or the interference filter has been exemplified as the optical element according to the invention in each of the embodiments described above, the invention is not limited thereto. For example, a mirror device that can accurately change the light reflection direction can be exemplified as the optical element.

In addition, although the wavelength tunable interference filter 5 has been exemplified as an optical element, it is also possible to use an interference filter in which the electrostatic actuator 56 is not provided and the size of a gap between the reflective films 54 and 55 is fixed.

In the fourth embodiment, the colorimetric apparatus 1 has been exemplified as the electronic apparatus according to the invention. However, the optical device, the optical module, and the electronic apparatus according to the invention can be applied in various fields.

For example, the optical device, the optical module, and the electronic apparatus according to the invention can be used as a light-based system for detecting the presence of a specific material. As examples of such a system, an in-vehicle gas leak detector that detects a specific gas with high sensitivity by adopting a spectroscopic measurement method using the wavelength tunable interference filter provided in the optical device according to the invention or a gas detector, such as a photoacoustic rare gas detector for mammography, can be exemplified.

An example of such a gas detector will now be described with reference to the accompanying drawings.

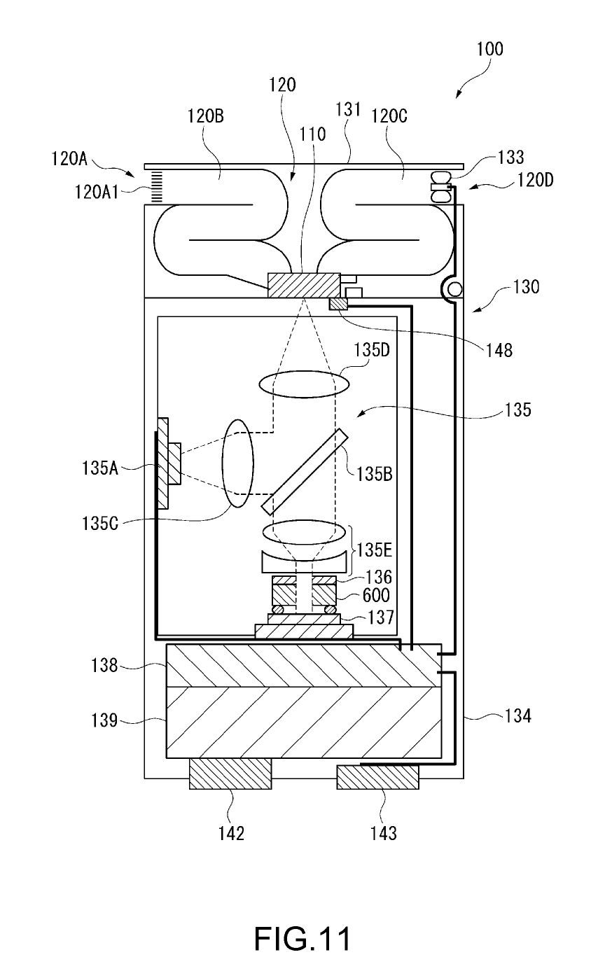

FIG. 11 is a schematic diagram showing an example of a gas detector including the wavelength tunable interference filter.

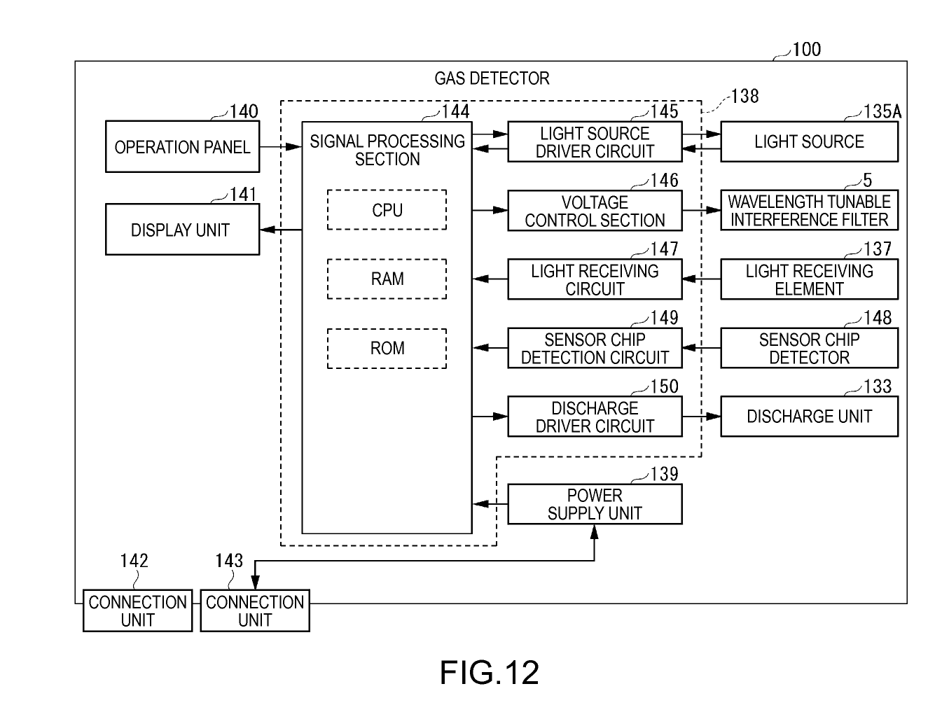

FIG. 12 is a block diagram showing the configuration of a control system of the gas detector shown in FIG. 11.

As shown in FIG. 11, a gas detector 100 is configured to include a sensor chip 110, a flow path 120 including a suction port 120A, a suction flow path 120B, a discharge flow path 120C, and a discharge port 120D, and a main body 130.

The main body 130 is configured to include: a detection device including a sensor unit cover 131 having an opening through which the flow path 120 can be attached or detached, a discharge unit 133, a housing 134, an optical unit 135, a filter 136, the optical filter device 600, and a light receiving element 137 (detection unit); a control unit 138 that processes a detected signal and controls the detection unit; and a power supply unit 139 that supplies electric power. Instead of the optical filter device 600, the optical filter devices 600A and 600B in the second and third embodiments may also be used. In addition, the optical unit 135 is configured to include a light source 135A that emits light, a beam splitter 135B that reflects light incident from the light source 135A toward the sensor chip 110 side and transmits light incident from the sensor chip side toward the light receiving element 137 side, and lenses 135C, 135D, and 135E.

In addition, as shown in FIG. 11, an operation panel 140, a display unit 141, a connection unit 142 for interface with the outside, and the power supply unit 139 are provided on the surface of the gas detector 100. When the power supply unit 139 is a secondary battery, a connection unit 143 for charging may be provided.

As shown in FIG. 12, the control unit 138 of the gas detector 100 includes a signal processing section 144 formed by a CPU or the like, a light source driver circuit 145 for controlling the light source 135A, a voltage control section 146 for controlling the wavelength tunable interference filter 5 of the optical filter device 600, a light receiving circuit 147 that receives a signal from the light receiving element 137, a sensor chip detection circuit 149 that reads a code of the sensor chip 110 and receives a signal from a sensor chip detector 148 that detects the presence or absence of the sensor chip 110, and a discharge driver circuit 150 that controls the discharge unit 133.

Next, the operation of the gas detector 100 will be described below.

The sensor chip detector 148 is provided inside the sensor unit cover 131 located in the upper portion of the main body 130, and the presence or absence of the sensor chip 110 is detected by the sensor chip detector 148. When a detection signal from the sensor chip detector 148 is detected, the signal processing section 144 determines that the sensor chip 110 has been mounted, and outputs a display signal to display that “detection operation is executable” on the display unit 141.

Then, for example, when the operation panel 140 is operated by the user and an instruction signal indicating the start of detection processing is output from the operation panel 140 to the signal processing section 144, the signal processing section 144 first outputs a signal for operating the light source to the light source driver circuit 145 to operate the light source 135A. When the light source 135A is driven, linearly-polarized stable laser light with a single wavelength is emitted from the light source 135A. A temperature sensor or a light amount sensor is provided in the light source 135A, and the information is output to the signal processing section 144. When it is determined that the light source 135A is stably operating based on the temperature or the amount of light input from the light source 135A, the signal processing section 144 controls the discharge driver circuit 150 to operate the discharge unit 133. Then, a gas sample containing a target material (gas molecules) to be detected is guided from the suction port 120A to the suction flow path 120B, the inside of the sensor chip 110, the discharge flow path 120C, and the discharge port 120D.

A dust filter 120A1 is provided on the suction port 120A in order to remove relatively large dust particles, water vapor, and the like.

The sensor chip 110 is a sensor in which a plurality of metal nanostructures are included and which uses localized surface plasmon resonance. In such a sensor chip 110, an enhanced electric field is formed between the metal nanostructures by laser light. When gas molecules enter the enhanced electric field, Rayleigh scattered light and Raman scattered light including the information of molecular vibration are generated.

Such Rayleigh scattered light or Raman scattered light is incident on the filter 136 through the optical unit 135, and the Rayleigh scattered light is separated by the filter 136 and the Raman scattered light is incident on the optical filter device 600. Then, the signal processing section 144 controls the voltage control section 146 to adjust a voltage applied to the wavelength tunable interference filter 5 of the optical filter device 600, and separates the Raman scattered light corresponding to gas molecules to be detected using the wavelength tunable interference filter 5 of the optical filter device 600. Then, when the separated light is received by the light receiving element 137, a light receiving signal corresponding to the amount of received light is output to the signal processing section 144 through the light receiving circuit 147.

The signal processing section 144 determines whether or not the gas molecules to be detected obtained as described above are target gas molecules by comparing the spectral data of the Raman scattered light corresponding to the gas molecules to be detected with the data stored in the ROM, and specifies the material. In addition, the signal processing section 144 displays the result information on the display unit 141, or outputs the result information to the outside through the connection unit 142.

In FIGS. 11 and 12, the gas detector 100 that performs gas detection from the Raman scattered light separated by the wavelength tunable interference filter 5 of the optical filter device 600 is exemplified. In addition, as a gas detector, it is also possible to use a gas detector that specifies the type of gas by detecting the gas-specific absorbance. In this case, a gas sensor that detects light absorbed by gas, among incident light, after making gas flow into the sensor is used as the optical module according to the invention. In addition, a gas detector that analyzes and determines gas flowing into the sensor using a gas sensor is used as the electronic apparatus according to the invention. Also in such a configuration, it is possible to detect components of gas using the wavelength tunable interference filter.

In addition, as a system for detecting the presence of a specific material, a material component analyzer, such as a non-invasive measuring apparatus for obtaining the information regarding sugar using near-infrared spectroscopy or a non-invasive measuring apparatus for obtaining information regarding food, minerals, living bodies, and the like can be exemplified without being limited to the gas detection described above.

Hereinafter, a food analyzer will be described as an example of the material component analyzer.

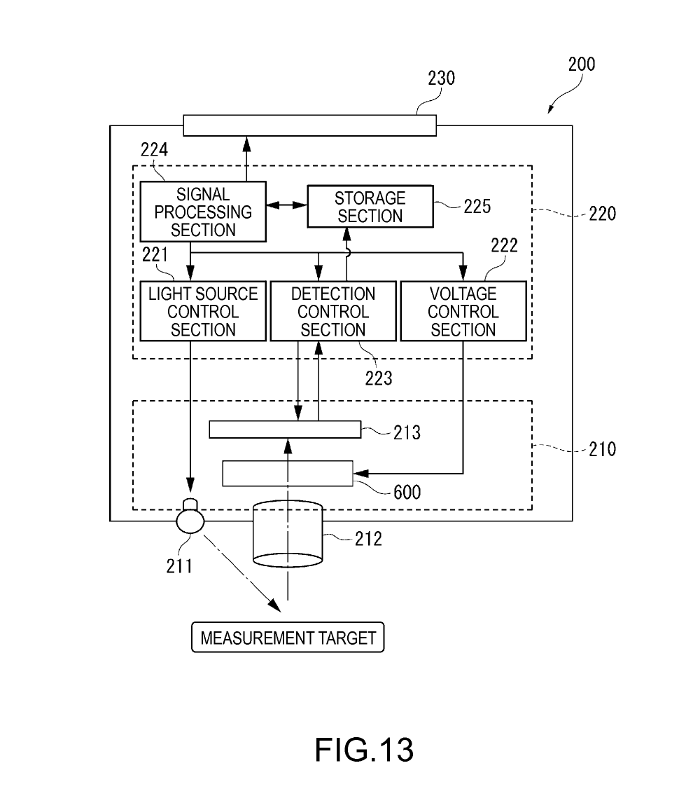

FIG. 13 is a drawing showing the schematic configuration of a food analyzer that is an example of an electronic apparatus using the optical filter device 600.

As shown in FIG. 13, a food analyzer 200 includes a detector 210 (optical module), a control unit 220, and a display unit 230. The detector 210 includes a light source 211 that emits light, an imaging lens 212 to which light from a measurement target is introduced, the optical filter device 600 that can separate the light introduced through the imaging lens 212, and an imaging unit 213 (detection section) that detects the separated light. Instead of the optical filter device 600, the optical filter devices 600A and 600B in the second and third embodiments may also be used.

In addition, the control unit 220 includes a light source control section 221 that performs ON/OFF control of the light source 211 and brightness control at the time of lighting, a voltage control section 222 that controls the wavelength tunable interference filter 5 of the optical filter device 600, a detection control section 223 that controls the imaging unit 213 and acquires a spectral image captured by the imaging unit 213, a signal processing section 224, and a storage section 225.

In the food analyzer 200, when the system is driven, the light source control section 221 controls the light source 211 so that light is emitted from the light source 211 to the measurement target. Then, light reflected by the measurement target is incident on the optical filter device 600 through the imaging lens 212. By the control of the voltage control section 222, a voltage by which light having a desired wavelength can be separated is applied to the wavelength tunable interference filter 5 of the optical filter device 600. The separate light is imaged by the imaging unit 213 formed by a CCD camera, for example. The imaged light is stored in the storage section 225 as a spectral image. The signal processing section 224 changes the value of a voltage applied to the wavelength tunable interference filter 5 by controlling the voltage control section 222, thereby obtaining a spectral image for each wavelength.

Then, the signal processing section 224 calculates a spectrum in each pixel by performing arithmetic processing on the data of each pixel in each image stored in the storage section 225. For example, information regarding the components of the food for the spectrum is stored in the storage section 225. The signal processing section 224 analyzes the data of the obtained spectrum based on the information regarding food stored in the storage section 225, and calculates food components contained in the detection target and the content thereof. In addition, food calories, freshness, and the like can be calculated from the obtained food components and content. By analyzing the spectral distribution in the image, it is possible to extract a portion, of which freshness is decreasing, in the food to be examined. In addition, it is also possible to detect foreign matter contained in the food.

Then, the signal processing section 224 performs processing for displaying the information obtained as described above, such as the components or the content of the food to be examined and the calories or freshness of the food to be examined, on the display unit 230.

Although an example of the food analyzer 200 is shown in FIG. 13, the invention can also be used as a non-invasive measuring apparatus for obtaining other information, as described above by applying substantially the same configuration. For example, the invention can be used as a biological analyzer for the analysis of biological components involving the measurement and analysis of body fluids, such as blood. For example, if an apparatus that detects ethyl alcohol is used as the apparatus for measuring the body fluids, such as blood, the biological analyzer can be used as a drunk driving prevention apparatus that detects the blood alcohol level of the driver. In addition, the invention can also be used as an electronic endoscope system including such a biological analyzer.

In addition, the invention can also be used as a mineral analyzer for analyzing the components of minerals.

The wavelength tunable interference filter, the optical module, and the electronic apparatus according to the invention can be applied to the following apparatuses.

For example, it is possible to transmit data with light of each wavelength by changing the intensity of light of each wavelength with time. In this case, data transmitted by light having a specific wavelength can be extracted by separating the light having a specific wavelength using a wavelength tunable interference filter provided in the optical module and receiving the light having a specific wavelength using a light receiving unit. By processing the data of light of each wavelength using an electronic apparatus including such an optical module for data extraction, it is also possible to perform optical communication.

The electronic apparatus can also be applied to a spectral camera, a spectral analyzer, and the like for capturing a spectral image by separating light using a wavelength tunable interference filter. As an example of such a spectral camera, an infrared camera including a wavelength tunable interference filter can be exemplified.

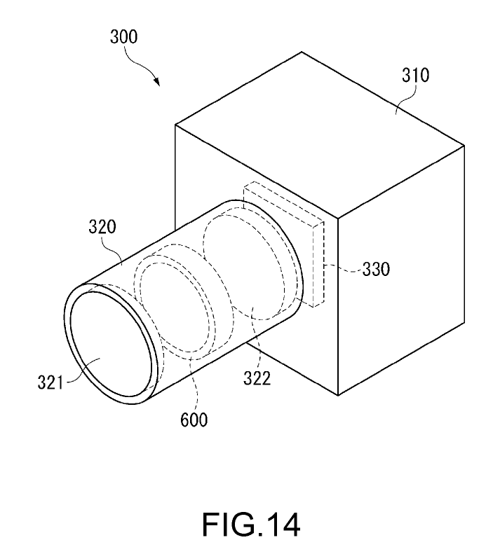

FIG. 14 is a schematic diagram showing the configuration of a spectral camera. As shown in FIG. 14, a spectral camera 300 includes a camera body 310, an imaging lens unit 320, and an imaging unit 330 (detection unit).

The camera body 310 is a portion held and operated by the user.

The imaging lens unit 320 is provided on the camera body 310, and guides incident image light to the imaging unit 330. In addition, as shown in FIG. 14, the imaging lens unit 320 is configured to include an objective lens 321, an imaging lens 322, and the optical filter device 600 provided between these lenses. Instead of the optical filter device 600, the optical filter devices 600A and 600B in the second and third embodiments may also be used.

The imaging unit 330 is formed by a light receiving element, and images image light guided by the imaging lens unit 320.

In the spectral camera 300, a spectral image of light having a desired wavelength can be captured by transmitting the light having a wavelength to be imaged using the wavelength tunable interference filter 5 of the optical filter device 600.

In addition, it is also possible to use an optical device that uses the wavelength tunable interference filter as a band pass filter. For example, the optical device according to the invention can also be used as an optical laser device that separates and transmits only light in a narrow band having a predetermined wavelength at the center, of light in a predetermined wavelength band emitted from a light emitting element, using the wavelength tunable interference filter.

In addition, the wavelength tunable interference filter housed in the optical device according to the invention may be used as a biometric authentication device. For example, the wavelength tunable interference filter according to the invention can also be applied to authentication devices of blood vessels, fingerprints, retinas, irises, and the like using light in a near infrared region or a visible region.

In addition, the optical module and the electronic apparatus can be used as a concentration detector. In this case, using a wavelength tunable interference filter, infrared energy (infrared light) emitted from a material is separated and analyzed, and the object concentration in a sample is measured.

As described above, the optical device, the optical module, and the electronic apparatus according to the invention can also be applied to any apparatus that separates predetermined light from incident light. In addition, since the optical device described above can separate light beams with a plurality of wavelengths using one device as described above, measurement of the spectrum of a plurality of wavelengths, and detection of a plurality of components can be accurately performed. Accordingly, compared with a known apparatus that extracts a desired wavelength using a plurality of devices, it is possible to make an optical module or an electronic apparatus small. Therefore, the optical device according to the invention can be appropriately used in a portable electronic apparatus or an in-vehicle electronic apparatus, for example.

In addition, the specific structure when implementing the invention may be formed by appropriately combining the respective embodiments described above and modification examples in a range where the object of the invention can be achieved, or may be appropriately changed to other structures or the like.

The entire disclosure of Japanese Patent Application No. 2013-183796, filed Sep. 5, 2013 is expressly incorporated by reference herein.

What is claimed is:

1. An optical device, comprising:
an optical element;
a first member that is disposed so as to cover the optical element, and that has an opening;
a second member that is disposed so as to face the first member with the optical element interposed therebetween, and that houses the optical element together with the first member;
a third member that covers the opening so as to transmit light; and
a metal layer that covers the first member,
wherein, when a side of the opening is viewed from the third member, the metal layer does not overlap the third member on a side of the first member facing the third member.

2. The optical device according to claim 1,
wherein the third member is bonded to the first member.

3. The optical device according to claim 1,
wherein the metal layer is formed by a plating method.

4. The optical device according to claim 1,
wherein the third member is bonded to the first member through low melting point glass.

5. The optical device according to claim 4, further comprising:
a resin member that covers a surface of the low melting point glass that is not in contact with the first and third members.

6. The optical device according to claim 5,
wherein the third member has a first surface facing the first member and a second surface that is continuous with an outer peripheral edge side of the third member from the first surface, the second surface is inclined in a direction away from the first member toward the outer peripheral edge of the third member,
the low melting point glass is disposed between the first surface and the first member, and
the resin member is in contact with the second surface.

7. The optical device according to claim 1,
wherein the third member is formed of glass,
the first member is formed of Kovar, and
the metal layer contains nickel.

8. The optical device according to claim 1,
wherein the optical element is an interference filter including a pair of reflective films facing each other.

9. An optical module, comprising:
an optical device that includes an interference filter including a pair of reflective films facing each other, a first member having an opening, a second member that is disposed so as to face the first member with the interference filter interposed therebetween and that houses the interference filter together with the first member, a third member that covers the opening so as to transmit light, and a metal layer that covers the first member; and
a light receiving unit that receives light emitted from the interference filter,
wherein, when a side of the opening is viewed from the third member, the metal layer does not overlap the third member on a side of the first member facing the third member.

10. An electronic apparatus, comprising:
an optical device according to claim 1; and
a control unit that controls the interference filter.

11. An optical housing, comprising:
a first member that has an opening;
a second member that houses an optical element together with the first member;
a third member that covers the opening so as to transmit light; and
a metal layer that covers the first member,
wherein, when a side of the opening is viewed from the third member, the metal layer does not overlap the third member on a side of the first member facing the third member.
